(19) United States
(12) Patent Application Publication
(10) Pub. No.: US 2008/0282230 A1
(43) Pub. Date: Nov. 13, 2008

(54) PRODUCT, METHOD AND SYSTEM FOR USING WINDOW AUTHENTICATION IN TESTING GRAPHICAL USER INTERFACE APPLICATIONS

(75) Inventors: Marcus Lee Belvin, Raleigh, NC (US); Christopher Michael Broglie, Doylestown, PA (US); Michael James Frederick, San Diego, CA (US); David James Hawkey, Schenectady, NY (US)

Correspondence Address: LEE LAW, PLLC;IBM CUSTOMER NUMBER, P.O. BOX 189, PITTSBORO, NC, 27312, US

(73) Assignee: INTERNATIONAL BUSINESS MACHINES CORPORATION, Armonk, NY (US)

(21) Appl. No.: 11/745,433

(22) Filed: May 7, 2007

(51) Int. Cl. G06F 9/44

(52) U.S. Cl. 717/125

(57) ABSTRACT

The invention discloses an authentication technique for allowing an automated testing program to determine whether a failure during software application testing is caused by an event unrelated to the test, in order to improve correction of programming defects discovered using automated testing. Specifically, a product, method and system is provided for using window authentication in testing graphical user interface (GUI) applications.

### TECHNICAL FIELD

The invention relates to correction of programming defects discovered using automated testing.

### BACKGROUND

Computer software application program development often requires utilization of various testing processes to verify that a programmed application will function properly when placed into actual use. However, frequently changing product designs and/or development plans, application program interfaces (APIs) and recurrent feature regression introduce variables that ad-hoc testing practices are often unable to handle, necessitating use of automated functional and regression testing program tools (such as IBM Rational Functional Tester®) for programmers to use in testing standalone, networked, internet web-based (and other types of) applications during their development.

Such automated testing programs record simulated user interactions with the software application(s) being tested to create customizable program code (or “test script”) that reproduces those simulated actions when the test is executed. “Verification points” can be inserted into the test script to extract specified data or other properties obtained from the tested interactions, to allow comparison of expected results with “live” information obtained during testing to ensure correct functioning of the application program. Following test execution, the testing program generates a report (or “log”) recording the results of these verification point comparisons, and the test script can be modified based upon this recording activity to perform any data manipulation and/or operating environment changes necessary to ensure that the application program is properly configured for the next test run. With use of such automated testing programs, software developers are able to more reliably and efficiently expose problems in complex application programs, thereby increasing the opportunity for detecting, capturing and repairing programming defects (or “bugs”) before product release.

Many automated testing programs rely on identifying information from a windows-based operating system API (such as window/dialog box titles) to drive testing of software applications containing features displayed in a graphical user interface (GUI). The testing program uses this information to access the active window(s) and/or dialog box(es) of the application under test. However, an unexpected GUI window (such as a “firewall” dialog box) can sometimes appear (“pop up”) during test script execution, causing the test to anomalously fail because the test program was not provided with sufficient information to correctly process such an event. Instead, the testing program often categorizes such a failure as a “bug” without verifying that the test failed for an unanticipated reason.

### SUMMARY OF THE INVENTION

The invention provides an authentication technique for allowing an automated testing program to determine whether a failure during software application testing is caused by an event unrelated to the test, in order to improve correction of programming defects discovered using automated testing.

Specifically, a product, method and system is provided for using window authentication in testing graphical user interface (GUI) applications, in which a unique identifier (or “signature”) is added to authenticate an object property used in formulating an application program interface (API) function call made to create a window or dialog box (or other GUI output) for the tested application. The function call(s) made by the tested application to the operating system are intercepted by the automated testing program so that the “signature” can be added. The operating system then executes the function call to create a GUI object with the injected “signature” (such as a window with a unique title) so that the automated testing program is able to identify the object as corresponding to the tested application. This allows a window or dialog box (or other event) not possessing a recognized “signature” to be dismissed as an unrelated test failure instead of a programming defect in the tested application.

It is therefore an object of the present invention to provide an authentication technique for allowing an automated testing program to determine whether a failure during software application testing is caused by an event unrelated to the test, in order to improve correction of programming defects discovered using automated testing.

It is another object of the present invention to provide a product, method and system for using window authentication in testing graphical user interface (GUI) applications, in which a unique identifier (or “signature”) is added to authenticate an object property used in formulating an API function call made to create a window or dialog box (or other GUI output) for the tested application.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 illustrates the components of a computer system utilizing an automated testing program according to the invention.

FIGS. 2 & 3 illustrate a test script and verified output created by an automated testing program according to the invention.

FIG. 4 illustrates a graphical user interface (GUI) output of a software application utilizing an automated testing program according to the invention.

### DETAILED DESCRIPTION OF THE PREFERRED EMBODIMENTS

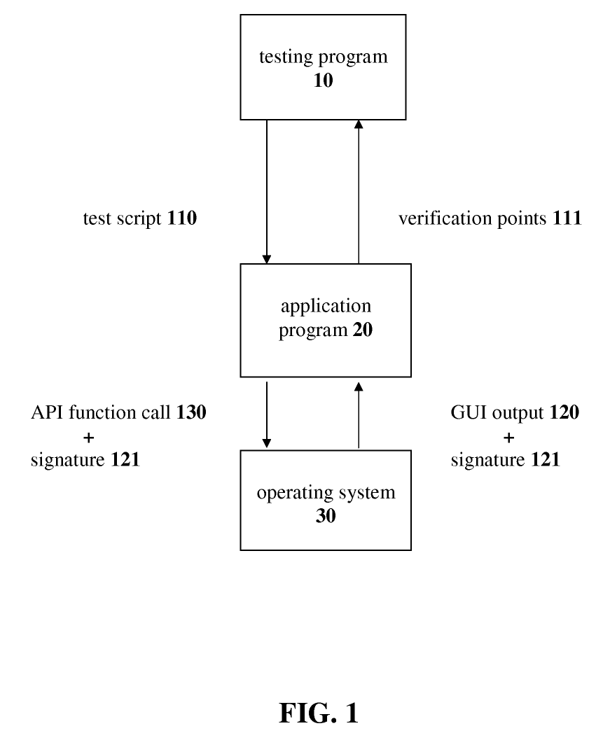

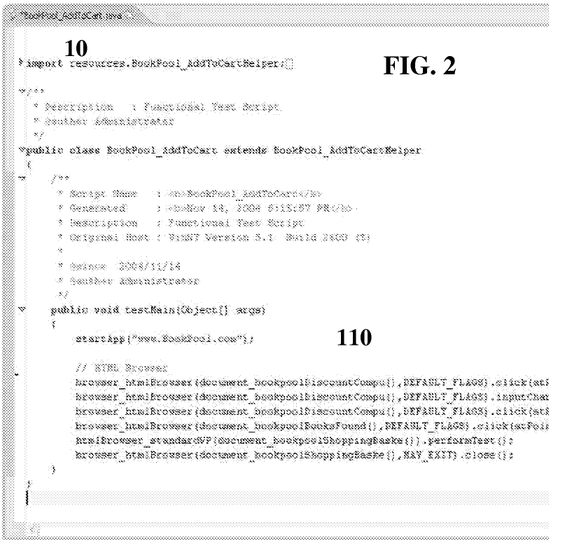

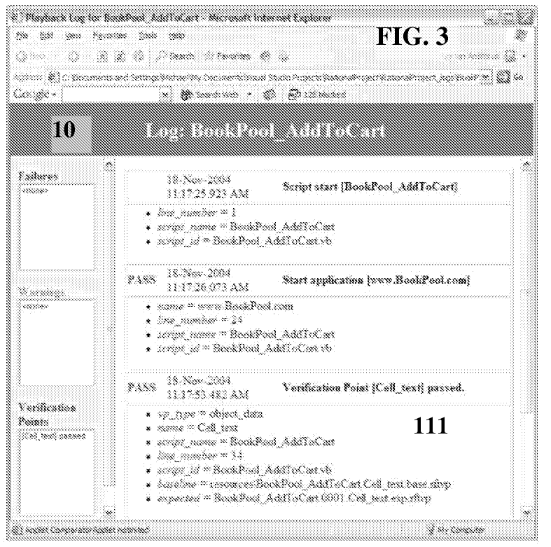

FIG. 1 illustrates a preferred embodiment of a computer system utilizing an automated testing program 10 (as implemented in Rational Functional Tester®) providing capabilities for testing Java, Microsoft® Visual Studio.NET and web-based applications, in which a “test script” 110 records the results of simulated user interactions with the application being tested by inserting “verification points” 111 to confirm the correct processing of an application program object 20 as shown in FIGS. 2 & 3. The test script records information based on the type of verification point used (i.e., an object function/properties verification point or a data verification point) and stores it in a baseline file to convey the expected state of the object during subsequent tests. After a test is executed, a “verification point comparator” feature can be used to analyze any differences (and/or update the baseline) in the expected object state if its behavior changes during the test.

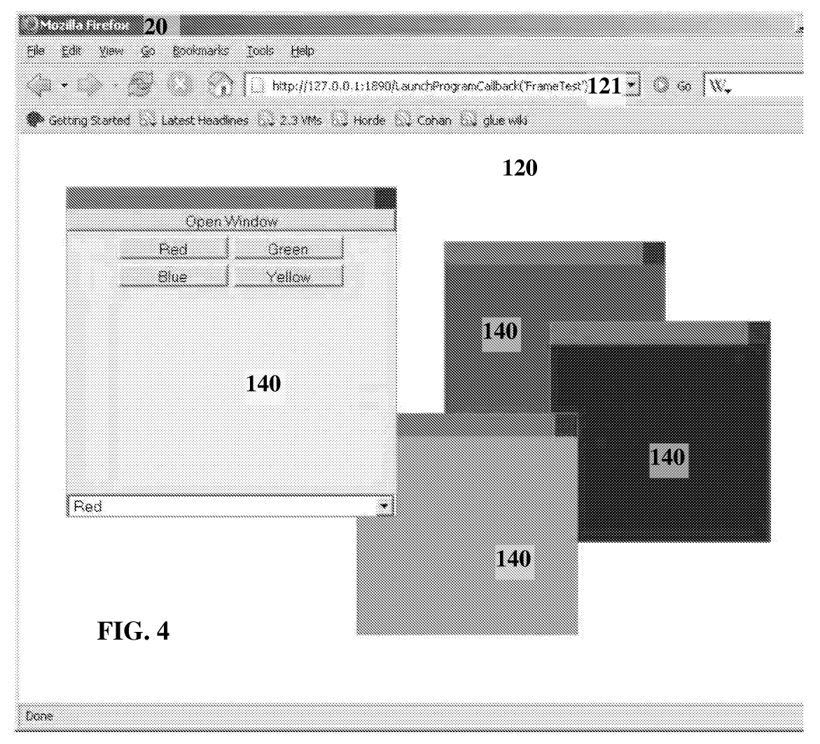

FIG. 4 illustrates a preferred embodiment of a graphical user interface (GUI) output for a software application 20 being tested by an automated program 10 that utilizes an authenticating identifier (or “signature”) feature 121 to determine whether a testing failure is caused by the appearance of an unrelated graphical user interface (GUI) output 140 rather than an application program defect. The “signature” 121 (which can be any identification code unique to the tested application output being created) is added to the window (or dialog box) title used in making an application program interface (API) function call 130 (forwarded by the testing program 10 via the tested application 20) to the windows-based operating system 30 (such as Microsoft Windows® or IBM OS/2® or Linux®) to create a GUI window or dialog box 120 (or other output) for the application being tested 20. This authenticating “signature” allows the testing program to determine whether an unrelated GUI window/dialog box (or other event) caused failure of a test (i.e., if it encounters an error created by an output window/dialog box that does not possess such a “signature”) in which case an application program defect (or “bug”) will not be reported as a cause of the failure. In such cases, the testing program may take a “screen shot” (or otherwise identify) the unrelated output window which can be used to modify the test script to allow correct processing of that output during future testing.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A computer system comprised of at least the following components containing program instructions executed to correct defects discovered during testing of a software application:
(a). an automated testing program comprised of a test script for recording the results of simulated user interactions to confirm the correct processing of one or more application program objects; and
(b). an application program containing at least one object tested by the automated program by adding a unique identification code to authenticate an object property used in formulating an application program interface function call made to an operating system to create a graphical user interface output for the object;
wherein the authentication code allows the testing program to determine whether a test failure is caused by an unrelated event instead of a programming defect in the tested software application.

2. The computer system of claim 1 wherein an application program defect is not reported as a cause of a test failure when an error is generated by a graphical user interface output not possessing the authentication code.

3. The computer system of claim 1 wherein the authentication code is added to a graphical user interface window or dialog box title.

4. The computer system of claim 1 wherein the testing program identifies an unrelated event for modification of the test script to allow correct processing of that event during future testing.

5. A method of using a computer system comprised of at least the following steps carried out by the following components containing program instructions executed to correct defects discovered during testing of a software application:
(a). configuring an automated testing program comprised of a test script to record the results of simulated user interactions for confirming the correct processing of one or more application program objects; and
(b). configuring an application program containing at least one object tested by the automated program by adding a unique identification code to authenticate an object property used in formulating an application program interface function call made to an operating system to create a graphical user interface output for the object;
wherein the authentication code allows the testing program to determine whether a test failure is caused by an unrelated event instead of a programming defect in the tested software application.

6. The method of claim 5 wherein an application program defect is not reported as a cause of a test failure when an error is generated by a graphical user interface output not possessing the authentication code.

7. The method of claim 5 wherein the authentication code is added to a graphical user interface window or dialog box title.

8. The method of claim 5 wherein the testing program identifies an unrelated event for modification of the test script to allow correct processing of that event during future testing.

9. A computer product used with a computer system and comprised of a computer readable storage medium containing program instructions executed by at least the following components of the computer system to correct defects discovered during testing of a software application:
(a). an automated testing program comprised of a test script for recording the results of simulated user interactions to confirm the correct processing of one or more application program objects; and
(b). an application program containing at least one object tested by the automated program by adding a unique identification code to authenticate an object property used in formulating an application program interface function call made to an operating system to create a graphical user interface output for the object;
wherein the authentication code allows the testing program to determine whether a test failure is caused by an unrelated event instead of a programming defect in the tested software application.

10. The computer product of claim 9 wherein an application program defect is not reported as a cause of a test failure when an error is generated by a graphical user interface output not possessing the authentication code.

11. The computer product of claim 9 wherein the authentication code is added to a graphical user interface window or dialog box title.

12. The computer product of claim 9 wherein the testing program identifies an unrelated event for modification of the test script to allow correct processing of that event during future testing.
